(19) United States
(12) Patent Application Publication
(10) Pub. No.: US 2022/0237316 A1
(43) Pub. Date: Jul. 28, 2022

(54) METHODS AND SYSTEMS FOR IMAGE SELECTION AND PUSH NOTIFICATION

(71) Applicant: Capital One Services, LLC, McLean, VA (US)

(72) Inventors: Joshua EDWARDS, Philadelphia, PA (US); Michael MOSSOBA, Great Falls, VA (US); Abdelkader BENKREIRA, Brooklyn, NY (US)

(73) Assignee: Capital One Services, LLC, McLean, VA (US)

(21) Appl. No.: 17/160,642

(22) Filed: Jan. 28, 2021

(51) Int. Cl. G06F 21/62; G06F 3/0484; G06T 7/70; G06K 9/00; G06T 7/20; G06T 7/00; H04L 29/08; H04N 21/44

(52) U.S. Cl. CPC G06F 21/6245; G06F 3/04842; G06T 7/70; G06K 9/00362; G06T 7/20; G06T 2207/10016; G06T 7/0002; H04L 67/26; H04N 21/44; G06T 2207/30168; G06T 2207/30201; G06K 9/00288

(57) ABSTRACT

Disclosed are methods, systems, and non-transitory computer-readable medium for image selection and push notification. For instance, the method may include receiving a data message from a device, extracting a video from the data message, processing the video to select at least one image from the video in accordance with image selection criteria including at least a blurriness criteria and a human orientation criteria, and determining a user associated with the data message. The method may further include transmitting a push notification including the at least one image to a user device associated with the user, receiving a user indication message from the user device, the user indication message including a user indication of a security issue or not, and performing a security action based on the user indication.

### TECHNICAL FIELD

Various embodiments of the present disclosure relate generally to methods and systems for image selection and push notification and, more particularly, to methods and systems for selecting a frame, multiple frames, or a video clip that includes a potentially recognizable face and including the selected image(s) or video in a push notification to a user device so that a user can initiate security actions if appropriate.

### BACKGROUND

When a device such as an automated teller machine (ATM) is used to access personal or financial resources, the owner of those resources may want to confirm the identity of the person gaining access via the device. Many devices that are equipped to access such personal or financial resources are or can be equipped with cameras to allow the operators of the devices to have records of those people using them. However the data collected by the device and/or the cameras is not accessible to the owner of the resources. Due at least in part to the sheer volume of data the device may be collecting, it would be resource intensive to store and transmit this data on a constant basis.

The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, systems and methods are disclosed for image selection and push notification. The systems and methods may provide useful security information to the owner of personal or financial resources being accessed, without requiring large and often unnecessary transmissions of captured data.

For instance, a method may include receiving a data message from a device, extracting a video from the data message, processing the video to select at least one image from the video in accordance with image selection criteria including at least a blurriness criteria and a human orientation criteria, and determining a user associated with the data message. The method may further include transmitting a push notification including the at least one image to a user device associated with the user, receiving a user indication message from the user device, the user indication message including a user indication of a security issue or not, and performing a security action based on the user indication.

A system may include a memory storing instructions; and a processor executing the instructions to perform a process. The process may include receiving a data message from a device, extracting a video from the data message, processing the video to select at least one image from the video in accordance with image selection criteria including at least a blurriness criteria and a human orientation criteria, determining a user associated with the data message, transmitting a push notification including the at least one image to a user device associated with the user. The process performed by the system may further include receiving a user indication message from the user device, with the user indication message including a user indication of a security issue or not, and performing a security action based on the user indication.

A non-transitory computer-readable medium may store instructions that, when executed by a processor, cause the processor to perform a method. The method may include receiving a push notification from a server, the push notification including at least one image of a person accessing a terminal and/or a live stream of the person accessing the terminal, and in response to receiving the push notification, displaying a push notification alert. The method may further include receiving a first user input to view the push notification alert, displaying the at least one image of the person and/or the live stream, receiving a second user input in relation to the at least one image and/or the live stream, determining whether the second user input indicates a first response or a second response. The method may also include, transmitting an affirmative message based upon a determination that the second user input indicates the first response, the affirmative message causing an initiation of a security action on the terminal, and transmitting a negative message based upon a determination that the second user input indicates the second response, the negative message allowing the person to continue accessing the terminal.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary block diagram of a system environment for image selection and notification, according to one or more embodiments.

FIG. 2 depicts a flowchart of an exemplary method of image selection and notification to perform a security action, according to one or more embodiments.

FIG. 3 depicts a flowchart for an exemplary method of initial image selection, according to one or more embodiments.

FIG. 4 depicts a flowchart for an exemplary method of image or video selection in response to a user input, according to one of more embodiments.

FIGS. 5A-5C depict exemplary user interfaces that may provide prompts to a user on a user device, according to one or more embodiments.

FIG. 6 depicts an example system that may execute techniques presented herein.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In general, the present disclosure is directed to methods and systems for selecting a frame, multiple frames, or a video clip that includes a potentially recognizable face from a larger collection of data, and then including the selected image(s) or video in a push notification to a user device. In particular, a system of the present disclosure may receive a data message from a device or terminal and extract a video from the data message. A system of the present disclosure may then process the video to identify a clear image of one of more persons using the terminal to access personal or financial resources and then send that image to a user associated with the resources being accessed. Upon receipt of the selected image, the user may respond with a number of appropriate responses, such as a request that security measures be initiated, a request for additional information such as additional image(s) or video clip(s), or an indication that no further action need be taken.

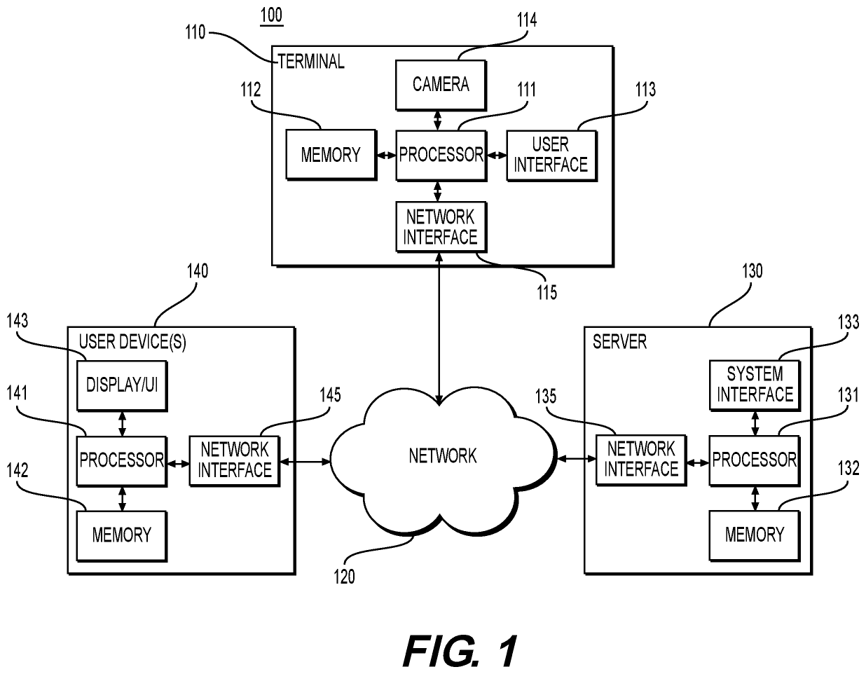

FIG. 1 depicts an exemplary block diagram of a system environment 100 according to one or more embodiments of the present disclosure. The system environment 100 may include a terminal 110 in communication with a server 130 via network 120. Network 120 may also connect terminal 110 and/or server 130 with a user device 140.

Terminal 110 may be an access point for personal or financial resources such as an ATM, and may include a processor 111 and a memory 112. Processor 111 may receive inputs from user interface 113, which may be an interface such as a touch screen panel, keyboard, or other suitable manner of displaying or otherwise communicating information and/or receiving user input. In some embodiments, camera 114 may be integrated into terminal 110, and the data collected may be transmitted to processor 111. Processor 111 can be in communication with other elements of the system environment 100 via network interface 115. Camera 114 may also be a separate device having its own processor and network interface which may communicate with terminal 110 and/or server 130 in any suitable manner. This interface may be a wired or wireless transmitter and receiver, and can also be implemented according to the present disclosure as a combination of wired and wireless connections. Network interface 115 can be selected to provide a proper connection between terminal 110 and any other device in the system environment 100, and in some embodiments those connections may be secure connections using communication protocols suitable for the information being transmitted and received.

Network 120 may be implemented as, for example, the Internet, a wireless network, a wired network (e.g., Ethernet), a local area network (LAN), a Wide Area Network (WANs), Bluetooth, Near Field Communication (NFC), or any other type of network or combination of networks that provides communications between one or more components of the system environment 100. In some embodiments, the network 120 may be implemented using a suitable communication protocol or combination of protocols such as a wired or wireless Internet connection in combination with a cellular data network.

Server 130 may be provided to carry out one or more steps of the methods according to the present disclosure. Server 130 may be a server of an institution and may include a processor 131 and a memory 132. Processor 131 may receive inputs via system interface 133, which may be an interface associated with the institution responsible for the custody of the personal or financial resources or the owner of terminal 110. System interface 133 may be used to update system programming stored in memory 132 in order to provide different or additional functionality to the system. Processor 131 can be in communication with other elements of the system environment 100 via network interface 135. Network interface 135 may be a wired or wireless transmitter and receiver, and can also be implemented according to the present disclosure as a combination of wired and wireless connections. In some embodiments, server 130 may include or be operably in communication with one or more databases associated with an institution to provide secure access to information regarding the personal or financial resources.

User device 140 may be a smartphone, tablet, or personal computer capable of providing and transmitting information to the owner of the personal or financial resources being accessed. User device 140 may include a processor 141 and a memory 142. Processor 141 may receive inputs from user interface 143, which may be an interface such as a touch screen, keyboard, or other suitable manner of displaying or otherwise communicating data and/or receiving user input. Processor 141 can be in communication with other elements of the system environment 100 via network interface 145. This interface may be a wired or wireless transmitter and receiver, and can also be implemented according to the present disclosure as a combination of wired and wireless connections. Network interface 145 can be selected to provide a proper connection between user device 140 and any other device in the system environment 100, and in some embodiments those connections may be secure connections using communication protocols suitable for the information being transmitted and received.

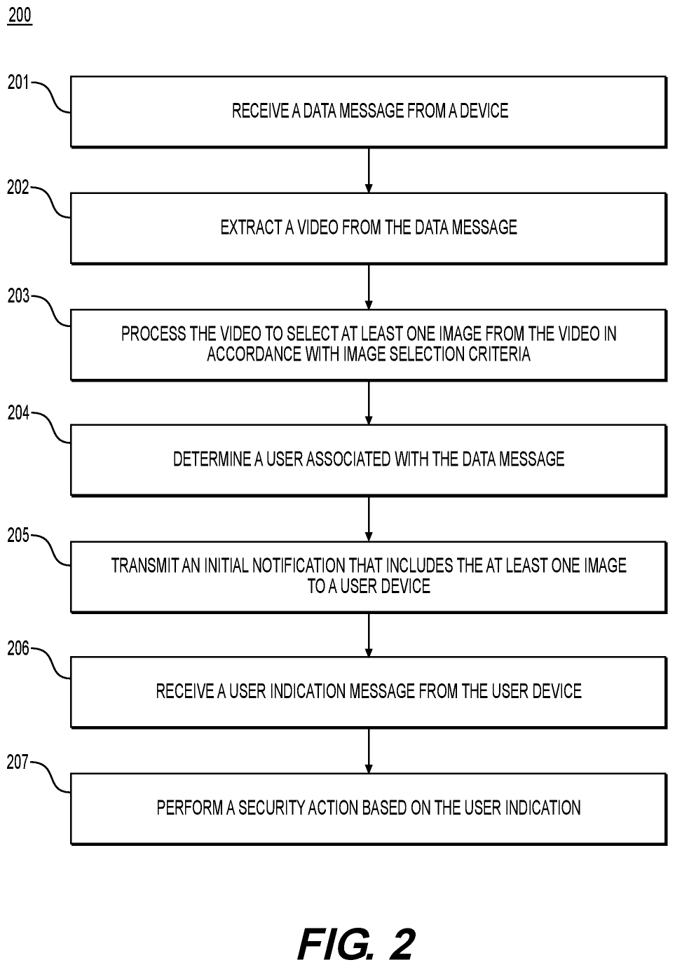

FIG. 2 depicts a flowchart illustrating a method 200 for image selection and push notification, according to one or more embodiments of the present disclosure. The method 200 may be performed by one or more of the devices that comprise the system environment 100.

Method 200 may begin at step 201 with the receipt of a data message from terminal 110. This message can include, for example, data collected from camera 114 and user interface 113. In some embodiments, the message may include data collected from other cameras or other devices, such as cameras that cover multiple terminals or systems that scan a user's credentials before providing access to a vestibule containing the terminal or terminals. This data may be automatically sent in response to a triggering event at the terminal 110, such as an interaction with user interface 113 or detecting motion via camera 114. In some embodiments, the data message may be sent in response to a query from server 130, such as one sent when the terminal 110 requests access to the personal or financial resources.

However the message is triggered, upon receipt at step 202, server 130 may extract relevant video from the data message. For example, the data message may cover a longer time period than the span of the transaction, and server 130 may extract a portion corresponding with the beginning of the terminal access event. This extraction can be performed by server processor 131, and the resulting extracted video can be stored for further processing (e.g., in memory 132). At step 203, server processor 131 can begin processing the video to select at least one image from the video for transmission to user device 140 as part of a push notification alert or other alert that access is being requested or occurring. Such a selection may be made in accordance with image selection criteria.

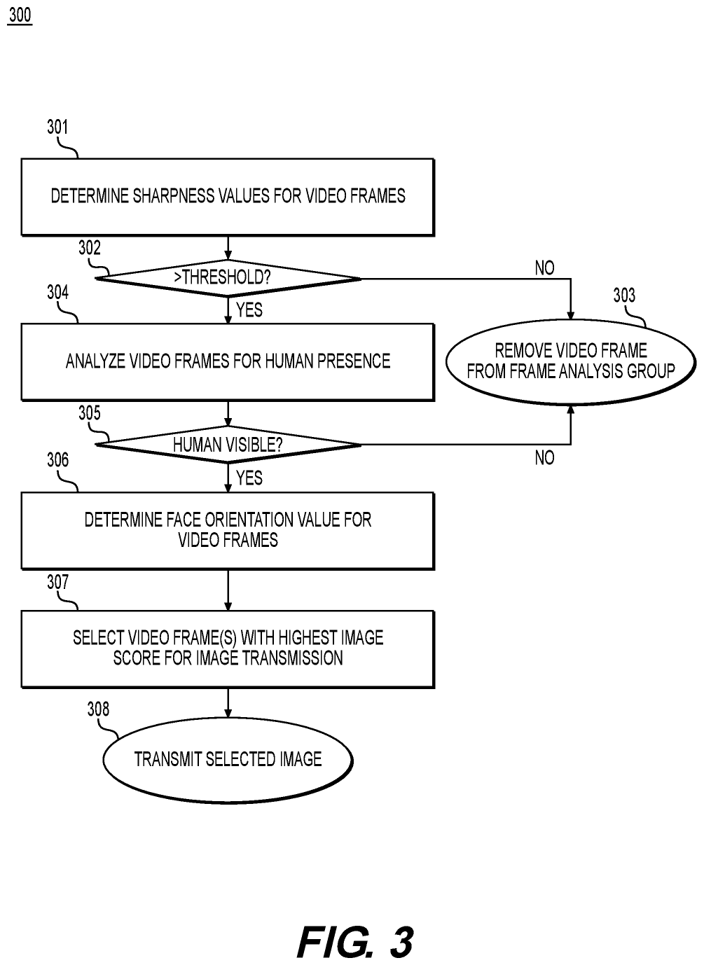

An example of step 203, in accordance with the present disclosure, is depicted in FIG. 3. Initial image selection method 300 can begin at step 301 with a blurriness analysis of the frames of the video extracted at step 202. The frames may be scored for sharpness by determining a sharpness value, and those sharpness values can be compared to a blurriness threshold. Server 130 may evaluate the sharpness and/or focus of the video frames using one or more algorithms that may include, for example, autofocus algorithms, edge detection algorithms, or other suitable methods. At step 302, those frames that are not sufficiently sharp (e.g., do not meet or exceed the threshold) (step 302: No) may be removed from the group of frames being analyzed (as indicated at reference label 303). This may have the benefit of reducing unnecessary processing of video frames that do not contain the desired information. Those frames that are sufficiently sharp (step 302: Yes) can be passed along to step 304 to be analyzed for subject matter. Step 304 may determine the presence of a figure identifiable as a human person, and at step 305 those video frames that are determined not to include a human person (step 305: No) can be removed. Determining which frames include a figure identifiable as a human person may be accomplished by one or more algorithms that may include, for example, facial detection algorithms or other suitable methods.

Those video frames that are both sufficiently sharp and include a person (step 305: Yes) may then be passed along to step 306. The analysis at step 306 may determine which video frames include not only a human person, but a person oriented such that their face is visible. This analysis may include a process of scoring the remaining video frames by determining a face orientation value for the frames. A relatively higher value may indicate a frame with a facial orientation more desirable for identification. A particular desirable facial orientation, such as a front view or profile, may be identified by suitable methods as are known in the art. In some embodiments, these face orientation values may fall within a certain range of face orientation thresholds or may simply pass a threshold in order to be passed along to the next step in the process. At step 307, the frame having the highest image score (e.g., highest sharpness value and/or face orientation value) can be selected for transmission. The highest scoring frame can be selected by a number of scoring algorithms or criteria to be satisfied such as the frame with the best face orientation value or the frame with the best combination of sharpness value and face orientation value. At step 308, the selected frame (or a relevant portion of the selected frame such as a cropped portion) may be transmitted to be reviewed by the owner of the personal or financial resources via user device 140. The remaining frames and/or the entire video may be then stored in server memory 132 to await further instructions and/or processing.

In some embodiments according to the present disclosure, image selection criteria in addition to and/or in lieu of blurriness criteria and human orientation criteria may be applied to further or differently score the images. Additional image selection criteria may include bounding box criteria, activity criteria, audio criteria, and/or biometric criteria. By applying these additional criteria, server 130 may improve its selection of an image having characteristics that may aid the user in determining whether or not the terminal access is authorized. Applying additional criteria may also result in an improved ability to score images in the event that additional information is requested at a later time. Some implementations of server 130 according to the present disclosure may also use a facial recognition process to determine whether or not a notification is necessary. In systems using facial recognition, the analysis above can include identifying and tracking a particular person or people, and conducting a facial recognition analysis on all or a portion of the video/video frames to identify the person or people. In some embodiments, if the recognized person is the owner of the personal or financial resources or another authorized user, a different or no notification may be sent.

Returning to FIG. 2, once an image has been selected at step 203, server 130 may use the data from the data message and information from an institutional database to determine a user associated with the personal or financial resources being accessed (step 204).

The user associated with the personal or financial resources may be identified by a number of pieces of information such as an account or Social Security number, facial recognition or other biometrics, or another suitably secure method. The institution responsible for the personal or financial resources being accessed may then be able to use a database stored on server 130 or in another suitable location accessible to server 130. The step of determining the user identity can result in server 130 identifying a user device 140 associated with the person or persons associated with the personal or financial resources being accessed. Having identified a user or user device 140 associated with the personal or financial resources being accessed (step 204) and having selected at least one image (step 203), server 130 can transmit an initial notification that includes the selected image(s) to the user device 140 (step 205). In some embodiments, prior to transmitting the initial notification, server 130 may attempt to locate user device 140. In the event that user device 140 is determined to be located at the terminal, server 130 may not send the initial notification.

Having transmitted the initial notification including the selected image (step 205), the owner of the personal or financial resources may review the notification on user device 140. The initial notification can provide security response options to the owner such as authorizing terminal access and taking no further security action in the event that, for example, the owner recognizes (or is themself) the person in the initial notification. Another potential security response option may include a request message to halt the terminal access or initiate other security actions in the event that the owner either doesn't recognize the person in the initial notification (or if the owner recognizes an unauthorized person) or perhaps identifies another reason to believe a security issue may have arisen.

Sometimes the owner may review the initial notification and be unsure if the terminal access should be authorized or not. For example, the server-selected image may not allow the owner to identify the person, it may only allow identification of one of multiple people present during account access, or may otherwise lack context necessary for the owner to make an appropriate decision. To address situations such as these, the initial notification may provide a response option requesting additional information. This request message for additional information can be, for example, a request for additional images or a request for all available terminal access data.

Once the user has had the opportunity to review the initial notification on user device 140, they can provide an indication message to server 130. Upon receipt of the user indication message (step 206), server 130 may perform a security action (step 207), if appropriate. For example, a user may indicate that they recognize and approve of the person conducting the transaction. In such a circumstance, upon receipt of a negative message (i.e. no need for security action), server 130 may allow the terminal 110 to continue with access to the personal or financial resources, and may note within server 130 that the access was approved by the user device 140. In some embodiments, user approval can initiate a data storage process such that data messages corresponding to approved transactions may be marked to be purged, compressed or abridged, and/or relocated to long term physical or cloud memory. For example, the data storage process flow may compress the data messages for approved transactions by creating a security log entry that may retain certain data while reducing the overall amount of data to be retained. Having a terminal access transaction ratified by the user can allow server 130 to more effectively distribute or conserve processing and network bandwidth, and can reduce the amount of resources required for server 130 to operate.

A user also may have reason to indicate that they do not recognize or do not approve of the person conducting the transaction. In such a circumstance, upon receipt of an affirmative message (i.e. security action needed), and provided the terminal access has not already concluded, server 130 may end the terminal's access to the personal or financial resources. In some embodiments, this action may also initiate a data storage process that causes data messages corresponding to unauthorized transactions to be marked for retention, and/or forwarded to appropriate security personnel at the institution or law enforcement. By taking actions such as these, server 130 may enable the user and/or institution to initiate security measures promptly and while the information is potentially more relevant. For example, if server 130 is able to prevent fraudulent or unauthorized access, and identify the person that attempted the fraud, that person's location and appearance can potentially lose value from a security standpoint as time goes on. Because a person can leave the scene and change their clothing and appearance, time can be a factor on being able to take certain security actions.

Even if the request message to halt or flag the terminal access is received after the completion of the session, or following the appropriate security action ending the session, server 130 may initiate post-access security actions. These security actions may include retaining the remaining video frames and/or the entire video, initiating a fraud process flow, temporarily preventing further access to the owner's resources, and/or contacting appropriate security or law enforcement authorities. When the terminal access is not prevented, a shortened response time may improve the possibility of asset recovery or suspect apprehension. Further, because it can be difficult and time consuming to review terminal access events at a later date, initiating security activities promptly may prevent a user from having to conduct a more difficult after-the-fact review of the access and subsequent transactions to determine which may have been unauthorized.

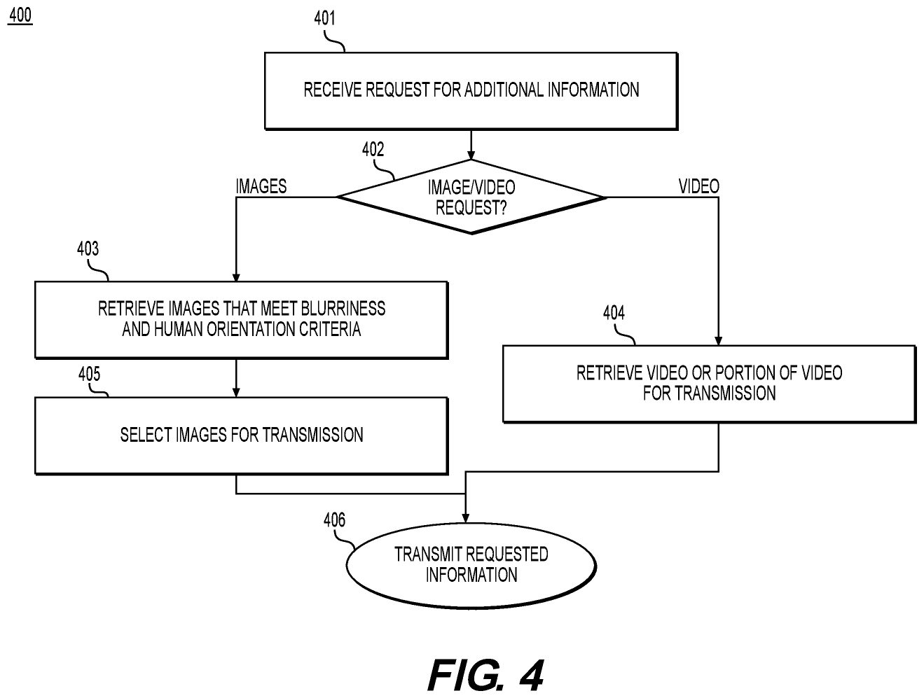

While server 130 may aim to provide the user with a useful image(s) in the initial notification, in some situations the initial notification may not include sufficient information for the user to determine whether or not the access is authorized. In these situations, the user indication may be a request for more information, such as additional images, video clips, or a live stream of the video from the terminal 110. An exemplary method of responding to a user request for additional information in accordance with the present disclosure is discussed in greater detail below and illustrated in FIG. 4.

As depicted in FIG. 4, method 400 can be initiated upon receipt of a request from the owner for additional information relating to the terminal access (step 401). At step 402, server 130 may determine what additional information is being requested. For example, the request may be for an additional image or series of images from the video. The request for more information may also request the entire video, or a relevant portion thereof. Depending on the specific information requested, server 130 may retrieve the previously scored images from method 300 (step 403), or server 130 may retrieve the entire video for transmission and/or begin to select an appropriate portion of the video for transmission (step 404).

If the request from the owner seeks additional images, server 130 may apply selection criteria to all or a portion of the video frames (step 405). For example, since some scored video frames may not have been sent with the initial notification, those frames already analyzed and known to be sufficiently sharp and include a person can be selected for transmission with minimal processing resources. By selecting based on the previous video frame scoring, server 130 may also be able to expedite a response to the request. Once server 130 has selected the responsive images (step 405) or video (step 404), server 130 may then transmit the requested information as an update message to the owner via network 120 to be viewed on user device 140 (step 406). Once the user has had the opportunity to review the additional information included in the update message, the user can select a security action element provided on the user device, and provide a second indication message to server 130. Upon receipt of the second user indication message, server 130 may perform a security action as discussed above with respect to step 207, as appropriate.

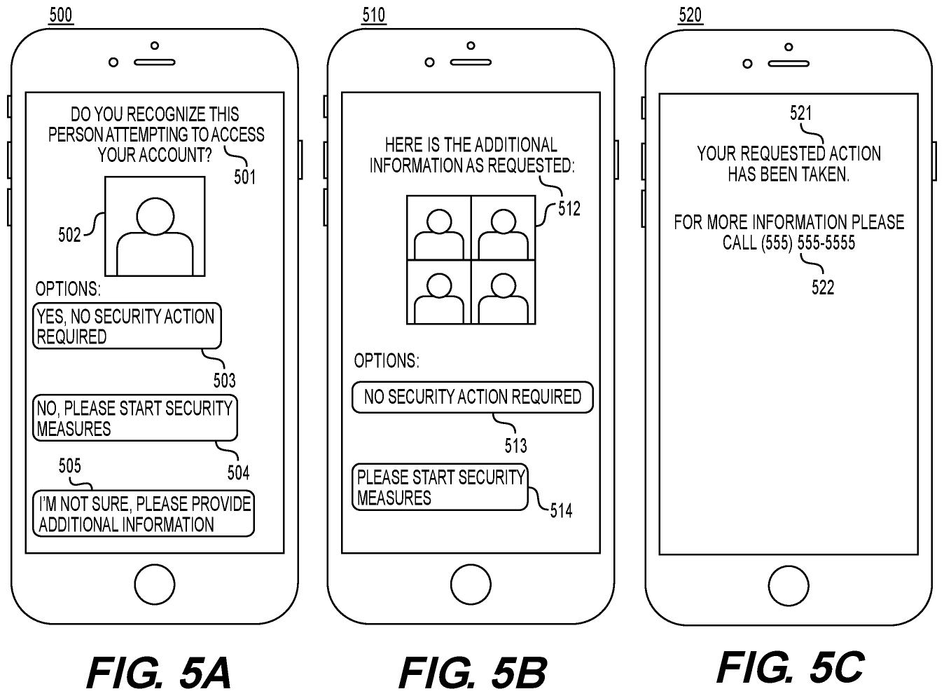

FIGS. 5A-5C illustrate exemplary graphical user interfaces (GUIs) 500, 510, 520 that may be displayed on user device 140. GUIs 500, 510, 520 may allow an owner to communicate with server 130 in order to send and receive messages and notifications. FIG. 5A is an example of how GUI 500 might provide the owner with an initial notification including notification text 501, the image 502 that server 130 selected from the video, and response options 503, 504, 505. Notification text 501 may include information such as the time of access, the type of terminal 110 accessed, and the location of the terminal 110. Exemplary GUI 500 provides the owner with security action elements representing the option to take no security action (503), the option to request security actions be taken (504), and the option to request additional information (505).

In accordance with the present disclosure, FIG. 5B illustrates how GUI 510 may provide the information requested when the owner selects option 505. GUI 510 can display the particular additional information (512) requested by the owner once it is received from server 130 via network 120. As discussed above, this additional information may include additional images and/or video. In some embodiments, the additional information is pushed directly to user device 140. Alternatively or in combination with pushing the information directly, an image or video display element may be displayed at 512 that directs the owner to another location such as a web page or mobile application. For example, server 130 may push additional images to be displayed at 512, while a link is provided to view the entire video or video clips. In exemplary GUI 510, the owner is presented with options that include an option to take no security action (513) and an option to request security actions be taken (514).

As shown in FIG. 5C, once the owner has been able to review the information provided and the appropriate action has been taken, exemplary GUI 520 may confirm the actions taken (521) and also provide additional information for any follow-up (522). The information for follow up 522 might include a reference to be used by the service provider to identify the event, and in some embodiments may include contact information for the service provider or the appropriate security or law enforcement entity.

Accordingly, server 130, in executing the methods shown and described above, may provide an owner of personal or financial resources with improved security and additional information about any access to those resources. The real-time alerts provided to the owner of the resources may provide for security improvements by either preventing unauthorized access or initiating security actions more promptly than they would be otherwise.

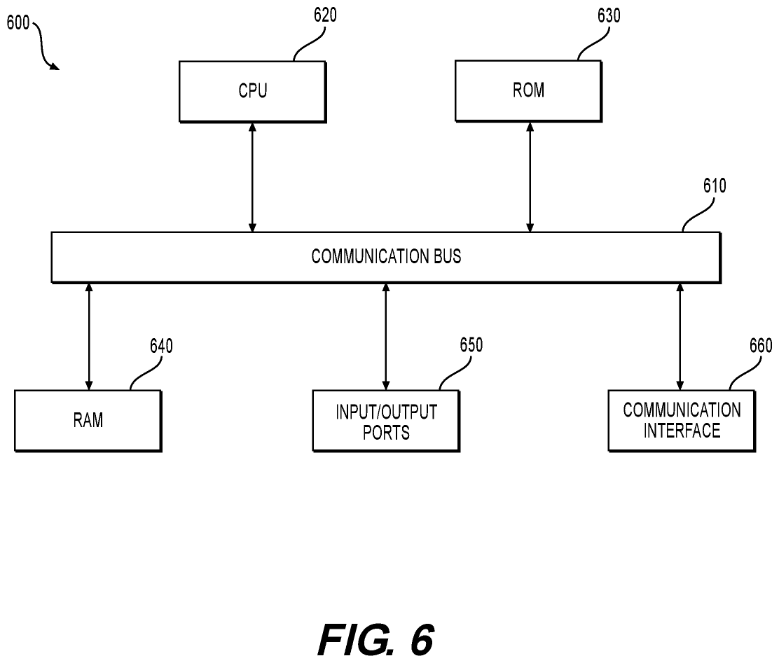

FIG. 6 depicts an example system that may execute techniques presented herein. FIG. 6 is a simplified functional block diagram of a computer that may be configured to execute techniques described herein, according to exemplary embodiments of the present disclosure. Specifically, the computer (or “platform” as it may not be a single physical computer infrastructure) may include a data communication interface 660 for packet data communication. The platform may also include a central processing unit 620 (“CPU”), in the form of one or more processors, for executing program instructions. The platform may include an internal communication bus 610, and the platform may also include a program storage and/or a data storage for various data files to be processed and/or communicated by the platform such as ROM 630 and RAM 640, although the system 600 may receive programming and data via network communications. The system 600 also may include input and output ports 650 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method, the computer-implemented method comprising:
receiving a data message from a device;
extracting a video from the data message;
processing the video to select at least one image from the video in accordance with image selection criteria, the image selection criteria including at least a blurriness criteria and a human orientation criteria;
determining a user associated with the data message;
transmitting a push notification to a user device associated with the user, the push notification including the at least one image;
receiving a user indication message from the user device, the user indication message including a user indication of a security issue or not; and
performing a security action based on the user indication.

2. The computer-implemented method of claim 1, wherein the image selection criteria further include one or more of: bounding box criteria, activity criteria, audio criteria, and biometric criteria.

3. The computer-implemented method of claim 1, further comprising, before receiving the user indication:
receiving a request message from the user device, the request message being transmitted in response to a user input selecting a push notification to view the at least one image;
processing the video to select a series of images from the video; and
transmitting an update message to the user device, the update message including the series of images.

4. The computer-implemented method of claim 3, wherein the user indication message is transmitted by the user device in response to a second user input selecting a security action element displayed in association with the series of images.

5. The computer-implemented method of claim 3, further comprising:
receiving a second request message from the user device, the second request message being transmitted in response to a second user input selecting a video display element to view the video;
processing the video to select a portion of the video; and
transmitting a second update message to the user device, the update message including the portion of the video.

6. The computer-implemented method of claim 1, wherein performing the security action based on the user indication includes:
initiating a fraud process flow and/or a storage process flow based on the user indication.

7. The computer-implemented method of claim 1, wherein processing the video to select the at least one image from the video in accordance with the image selection criteria includes:
determining whether any images of the video satisfy the blurriness criteria;
based upon a determination that one or more images satisfy the blurriness criteria, determining whether the one or more images satisfy the human orientation criteria; and
based upon a determination that image(s) of the one or more images satisfy the human orientation criteria, selecting the at least one image from the image(s).

8. The computer-implemented method of claim 7, wherein determining whether any images of the video satisfy the blurriness criteria includes:
determining one or more sharpness values for each of the images of the video;
determining whether any of the one or more sharpness values are greater than a blurriness threshold; and
based upon a determination that particular sharpness values are greater than the blurriness threshold, determining images corresponding to the particular sharpness values as the one or more images that satisfy the blurriness criteria.

9. The computer-implemented method of claim 7, wherein determining whether the one or more images satisfy the human orientation criteria includes:
determining whether the one or more images include a person;
based upon a determination that the one or more images include the person, analyzing the one or more images to determine face orientation values;
determining whether any of the face orientation values are within a range of face orientation thresholds; and
based upon a determination that particular face orientation values are within the range of face orientation thresholds, determining images corresponding to the particular face orientation values as the image(s) of the one or more images that satisfy the human orientation criteria.

10. The computer-implemented method of claim 1, further comprising, before transmitting the push notification to the user device associated with the user:
detecting and tracking a person in the video; and
performing a facial recognition process on images of the person to determine whether the person is an authorized user, wherein the push notification includes an indication of whether the person is the authorized user or not.

11. A system, the system comprising:
a memory storing instructions; and
a processor executing the instructions to perform a process including:
receiving a data message from a device;
extracting a video from the data message;
processing the video to select at least one image from the video in accordance with image selection criteria, the image selection criteria including at least a blurriness criteria and a human orientation criteria;
determining a user associated with the data message;
transmitting a push notification to a user device associated with the user, the push notification including the at least one image;
receiving a user indication message from the user device, the user indication message including a user indication of a security issue or not; and
performing a security action based on the user indication.

12. The system of claim 11, wherein the image selection criteria further include one or more of: bounding box criteria, activity criteria, audio criteria, and biometric criteria.

13. The system of claim 11, the process further includes, before receiving the user indication:
receiving a request message from the user device, the request message being transmitted in response to a user input selecting a push notification to view the at least one image;
processing the video to select a series of images from the video; and
transmitting an update message to the user device, the update message including the series of images.

14. The system of claim 13, wherein the user indication message is transmitted by the user device in response to a second user input selecting a security action element displayed in association with the series of images.

15. The system of claim 13, wherein the process further includes:
receiving a second request message from the user device, the second request message being transmitted in response to a second user input selecting a video display element to view the video;
processing the video to select a portion of the video; and
transmitting a second update message to the user device, the update message including the portion of the video.

16. The system of claim 11, wherein performing the security action based on the user indication includes:
initiating a fraud process flow and/or a storage process flow based on the user indication.

17. The system of claim 11, wherein processing the video to select the at least one image from the video in accordance with the image selection criteria includes:
determining whether any images of the video satisfy the blurriness criteria;
based upon a determination that one or more images satisfy the blurriness criteria, determining whether the one or more images satisfy the human orientation criteria; and
based upon a determination that image(s) of the one or more images satisfy the human orientation criteria, selecting the at least one image from the image(s).

18. The system of claim 17, wherein determining whether any images of the video satisfy the blurriness criteria includes:
determining one or more sharpness values for each of the images of the video;
determining whether any of the one or more sharpness values are greater than a blurriness threshold; and
based upon a determination that particular sharpness values are greater than the blurriness threshold, determining images corresponding to the particular sharpness values as the one or more images that satisfy the blurriness criteria.

19. The system of claim 17, wherein determining whether the one or more images satisfy the human orientation criteria includes:
determining whether the one or more images include a person;
based upon a determination that the one or more images include the person, analyzing the one or more images to determine face orientation values;
determining whether any of the face orientation values are within a range of face orientation thresholds; and
based upon a determination that particular face orientation values are within the range of face orientation thresholds, determining images corresponding to the particular face orientation values as the image(s) of the one or more images that satisfy the human orientation criteria.

20. A non-transitory computer-readable medium may store instructions that, when executed by a processor, cause the processor to perform a method, the method comprising:
receiving a push notification from a server, the push notification including at least one image of a person accessing a terminal and/or a live stream of the person accessing the terminal;
in response to receiving the push notification, displaying a push notification alert;
receiving a first user input to view the push notification alert;
displaying the at least one image of the person and/or the live stream;
receiving a second user input in relation to the at least one image and/or the live stream;
determining whether the second user input indicates a first response or a second response;
based upon a determination that the second user input indicates the first response, transmitting an affirmative message, the affirmative message causing an initiation of a security action on the terminal; and
based upon a determination that the second user input indicates the second response, transmitting a negative message, the negative message allowing the person to continue accessing the terminal.
